(19) United States
(12) Patent Application Publication
(10) Pub. No.: US 2025/0043725 A1
(43) Pub. Date: Feb. 6, 2025

(54) INTEGRATED AUXILIARY COMPRESSORS FOR COOLING IN GAS TURBINE ENGINES

(71) Applicant: Rolls-Royce North American Technologies Inc., Indianapolis, IN (US)

(72) Inventors: Timothy Unton, Indianapolis, IN (US); Ryan C. Humes, Indianapolis, IN (US)

(21) Appl. No.: 18/228,649

(22) Filed: Jul. 31, 2023

(51) Int. Cl. F02C 7/18; F02C 3/04; F23R 3/00

(52) U.S. Cl. CPC F02C 7/18; F02C 3/04; F23R 3/002; F05D 2220/32; F05D 2240/35; F05D 2260/202

(57) ABSTRACT

A gas turbine engine including an auxiliary compressor for pressuring cooling air delivered to turbine section components is disclosed. The auxiliary compressor is configured to increase the pressure of compressed air received from a primary compressor prior to movement of the compressed air to cooling air passageways of the turbine system.

### FIELD OF THE DISCLOSURE

The present disclosure relates generally to gas turbine engines, and more specifically to engines with components actively cooled with pressurized air.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Rotating detonation combustors and other pressure gain combustors designed for use in gas turbine engines can offer increased fuel efficiency and more compact systems over conventional deflagration-based combustors. Part of the gain in efficiency is due to a pressure rise occurring across the combustor rather than a pressure drop. From a fundamental cycle thermodynamics perspective, the pressure rise is desirable, but it presents a problem for turbines that receive products of the combustion reaction to extract mechanical energy.

Modern turbines operate at temperatures above their melting point by using cooling air that is fed through the blades and vanes of the turbine system. The cooling air is taken from the compressor, typically prior to discharge into the combustor. The cooling air is able to be driven through the blades and vanes of the turbine system because the pressure drop across typical combustors lowers pressure in the flow path of the turbine system. If the pressure increases across the combustor, as can be the case in rotating detonation combustors, the cooling air can no longer be forced through the turbine blades and vanes due to an adverse pressure gradient.

### SUMMARY

The present disclosure may comprise one or more of the following features and combinations thereof.

A gas turbine engine includes a primary compressor, a combustor, and turbine system. The primary compressor includes a primary compressor rotor mounted for rotation about an engine axis; and, the primary compressor configured to compress air drawn into the engine. The combustor is configured to produce a mixture of fuel and a portion of the compressed air, ignite the mixture, and to discharge products of the combustion reaction. The turbine system defines a flow path across which static vanes and rotating blades extend. The flow path is fluidly coupled to the combustor so as to receive products of the combustion reaction. The static vanes and rotating blades are formed to include cooling air passageways shaped to carry cooling air therethrough to lower the temperature of the associated static vanes and rotating blades.

In illustrative embodiments, the pressure gain combustor is a pressure gain combustor. The pressure gain combustor is configured to discharge products of the combustion reaction at a discharge pressure greater than an inlet pressure into the pressure gain combustor upstream of ignition. The pressure gain combustor may be a rotating detonation combustor.

In illustrative embodiments, the engine further includes an auxiliary compressor. The auxiliary compressor includes an auxiliary compressor rotor mounted for rotation about the engine axis. The auxiliary compressor is fluidly coupled to the compressor and to the cooling air passageways of the turbine system. The auxiliary compressor is configured to increase the pressure of compressed air received from the primary compressor upstream of cooling air passageways of the turbine system to overcome pressure within the flow path.

In illustrative embodiments, the auxiliary compressor rotor is coupled to the primary compressor rotor for rotation therewith. The primary compressor rotor may be mounted within a compressor case that includes a bleed port in fluid communication with the auxiliary compressor rotor. The primary compressor rotor may be a centrifugal compressor rotor and the compressor case can include a backing plate in which the bleed port is formed.

In illustrative embodiments, the auxiliary compressor rotor is an axial compressor rotor. The auxiliary compressor rotor can have a single stage of compressor blades.

In illustrative embodiments, the engine further includes an intercooler configured to cool compressed air that interacts with the auxiliary compressor rotor. The intercooler may be fluidly coupled between the auxiliary compressor rotor and the turbine system. The intercooler may be an air-to-fuel heat exchanger configured to transfer heat from compressed air after interaction with the auxiliary compressor rotor to fuel prior to mixing of the fuel within the pressure gain combustor.

A gas turbine engine includes a primary compressor rotor and a turbine system. The primary compressor rotor is mounted for rotation about an engine axis. The turbine system includes airfoils. The airfoils are formed to include cooling air passageways therethrough.

In illustrative embodiments, the engine further includes an auxiliary compressor. The auxiliary compressor rotor may be mounted for rotation about the engine axis. The auxiliary compressor rotor may be fluidly coupled between the primary compressor rotor and the cooling air passageways of the turbine system. The auxiliary compressor may be configured to increase the pressure of compressed air after interaction with the primary compressor rotor.

In illustrative embodiments, the auxiliary compressor rotor may be coupled to the primary compressor rotor for rotation therewith. The primary compressor rotor may be mounted within a compressor case that includes a bleed port in fluid communication with the auxiliary compressor rotor. The primary compressor rotor may be a centrifugal compressor rotor and the compressor case can include a backing plate in which the bleed port is formed.

In illustrative embodiments, the auxiliary compressor rotor is an axial compressor rotor. The auxiliary compressor rotor can have a single stage of compressor blades.

In illustrative embodiments, the engine includes an intercooler configured to cool compressed air that interacts with the auxiliary compressor rotor. The intercooler may be located upstream of the auxiliary compressor rotor. The intercooler may be located between the auxiliary compressor rotor and the turbine system.

A gas turbine engine includes a primary compressor rotor and a combustor. The primary compressor rotor may be mounted for rotation about an engine axis. The combustor may include a combustion liner formed to include cooling air passageways therethrough.

In illustrative embodiments, the engine further includes an auxiliary compressor rotor mounted for rotation about the engine axis. The auxiliary compressor rotor may be fluidly coupled between the primary compressor rotor and the cooling air passageways of the combustor. The auxiliary compressor may be configured to increase the pressure of compressed air after interaction with the primary compressor rotor.

These and other features of the present disclosure will become more apparent from the following description of the illustrative embodiments.

### BRIEF DESCRIPTION OF THE DRAWINGS

FIG. 1 is a perspective view of a turbofan gas turbine engine with a portion cut away to show, from left to right, a fan; a compressor; a combustor; and a turbine, and further showing diagrammatically that an integrated cooling air compressor is included in the engine;

FIG. 2 is a cross-sectional view of a portion of the engine in FIG. 1 showing the integrated cooling air compressor mounted for rotation along with the primary compressor; and, further showing that bleed air from the primary compressor is diverted from the combustor to feed the integrated cooling air compressor so that cooling air can be further pressurized before entering actively cooled turbine components; and

FIG. 3 is a diagrammatic view of a gas turbine engine showing potential flow through the engine.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

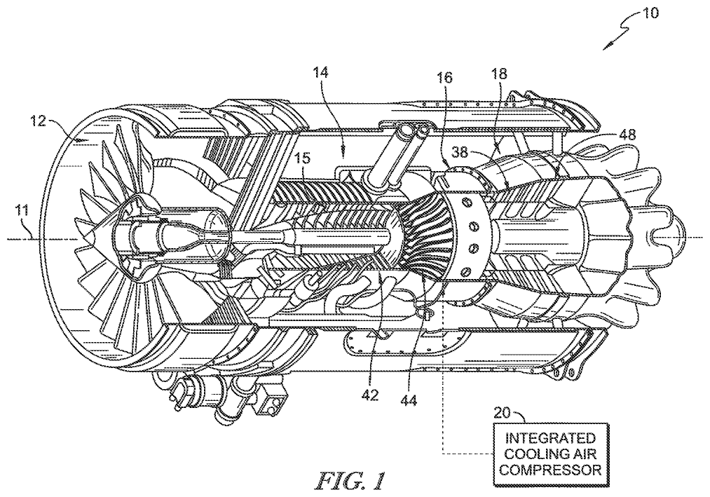

An illustrative gas turbine engine 10 includes a fan 12, a primary compressor 14, a combustor 16, and a turbine system 18 as shown in FIG. 1. The fan 12 is driven by the turbine system 18 and provides thrust for propelling the gas turbine engine 10. The primary compressor 14 compresses and delivers high pressure air to the combustor 16 and to the turbine system 18 for cooling. The combustor 16 mixes fuel with the compressed air received from the primary compressor 14 and ignites the fuel. The hot, high-pressure products of the combustion reaction in the combustor 16 are directed into the turbine system 18 to cause components of the turbine system 18 to rotate about a central axis 11 and drive the primary compressor 14 and the fan 12.

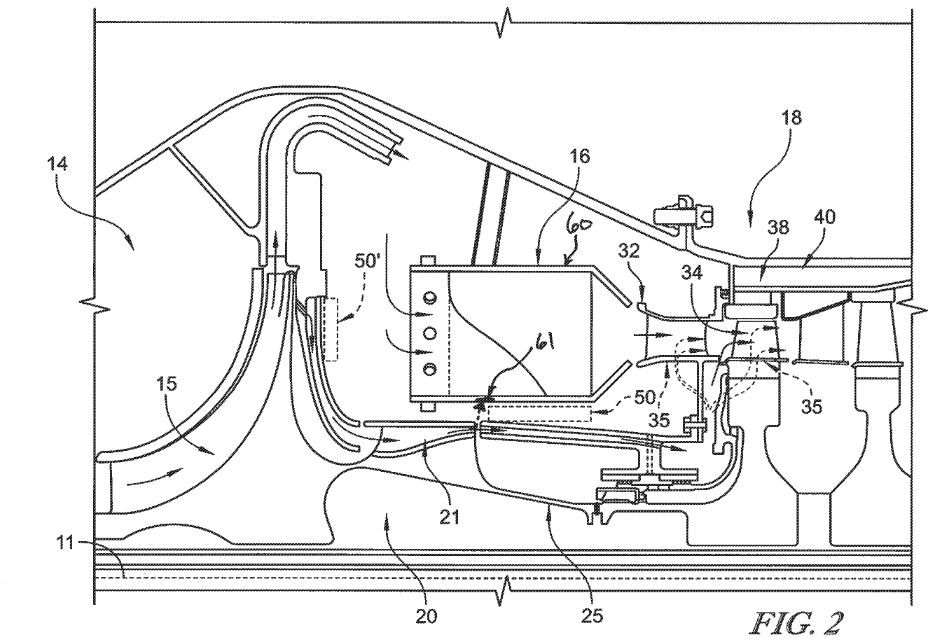

In the illustrative embodiment, the combustor 16 is a pressure gain combustor that implements rotating detonation to drive a pressure gain from its inlet having a first pressure P1 to its outlet having a second pressure P2 as suggested in FIG. 2. The increased pressure P2 discharged into the turbine system 18 requires that cooling air used within turbine system 18 components be pushed through the components and into the surrounding environment at the increased pressure P2. This is addressed in the presently disclosed design by the inclusion of an integrated cooling air compressor, also called an auxiliary compressor, 20 as shown in FIG. 2.

The auxiliary compressor 20 is fluidly coupled to the primary compressor 14 and to the turbine system 18 along a bypass flow path around the combustor 16 as shown in FIG. 2. The auxiliary compressor 20 is configured to increase the pressure of compressed air received from the compressor to drive a cooling air flow with pressure greater than the pressure P2 of the products of the combustion reaction discharged from the pressure gain combustor 16. Accordingly, the cooling air flow can be delivered to cooling air passageways 35 of the turbine system 18 and thereby cool the turbine system 18.

In the illustrative embodiment of FIG. 2, the auxiliary compressor 20 includes an auxiliary compressor rotor 21 that is integrated into a high pressure spool of the engine 10 along with a primary compressor rotor 15 and a high pressure turbine rotor 19. Said differently, the primary compressor rotor 15, the high pressure turbine rotor 19, and the auxiliary compressor rotor 21 are all coupled to a single high pressure shaft 25 for rotation together about an axis 11. In some embodiments, a gear set may be implemented between the high pressure shaft 25 and the auxiliary compressor rotor 21 so as to drive rotation of the auxiliary compressor rotor 21 at a stepped down or stepped up speed relative to the high pressure shaft.

In the illustrative embodiment, the auxiliary compressor 20 is arranged radially inwardly of the combustor 16 as shown in FIG. 2. Passageways defining the bypass flow path of air moving through the auxiliary compressor 20 are separated from the combustor 16 so that the cooling air can remain relatively cool before being fed to the turbine system 18 for cooling.

The auxiliary compressor 20 is made up of a single axial stage of compressor blades as shown in FIG. 2. In other embodiments, the compressor may have multiple stages of axial compressor blades and may have static compressor vanes. In some embodiments, the auxiliary compressor 20 may include a centrifugal compressor in place of, or in addition to, axial compression stages.

Some embodiments include an optional heat exchanger 50, 50′ as shown in FIG. 2. The heat exchanger 50, 50′ is configured to cool the cooling air flow as it moves to the turbine system 18.

The heat exchanger 50 is illustratively fluidly coupled between the auxiliary compressor 20 and the turbine system 18 as shown in FIG. 2. However in some designs the heat exchanger 50′ could be located between the primary compressor 14 and the auxiliary compressor 20; in such designs, cooling air is pulled rather than pushed through the heat exchanger 50′.

In the illustrative embodiment, the heat exchanger 50, 50′ is a fuel-to-air heat exchanger but can also be implemented as an air-to-air heat exchanger configured to transfer heat away from the cooling air flow to another flow of air moving through the engine. For example, heat can be transferred to bypass air pushed around an engine core by the fan 12.

FIG. 1 shows an exemplary turbofan engine layout. The primary compressor rotor 15 and a high pressure turbine rotor 19 included in the turbine system 18 are coupled to form a high-pressure core spool of the engine 10. The fan 12 and a low pressure turbine 48 of the turbine system 18 are coupled to form a low-pressure spool of the engine 10. As noted above, in the illustrative example, the auxiliary compressor rotor 21 is integrated into the high-pressure spool of the engine 10.

In some designs, combustors included in gas turbine engines may experience a pressure drop across the combustor. Due to the pressure drop, cooling air directly from an associated compressor can be forced into a flow path of the turbine system downstream of the combustor to cool components of the turbine system. However, the pressure gain combustor 16 in the exemplary embodiment experiences a pressure gain across the combustor 16. Because of the pressure gain across the pressure gain combustor 16, cooling air movement into the flow path of the turbine system 18 is resisted due to the adverse pressure gradient that can be created.

Though shown and described illustratively as a rotating detonation pressure gain combustor 16, the combustor 16 may be any combustor configured to have a pressure gain across the combustor. For example, wave rotor combustors, ram jet combustors, pulsed detonation combustors, resonant pulse combustors, and other suitable combustors can discharge combustion products at pressures greater than the combustor inlet pressure. Such other pressure gain combustors, or even other traditional non-pressure gain combustors, may be implemented in place of the illustrated combustor 16 while remaining within the spirit of this disclosure.

The high pressure turbine 38 of the illustrated embodiments include cooling air passageways 35 formed in static turbine vanes 32 and rotating turbine blades 34 as suggested in FIG. 1. Cooling air passageways 35 in these airfoils are fed cooling air after it has been pressurized by auxiliary compressor 20. The cooling air used in the cooling air passageways 35 of the static turbine vanes 32 and the rotating turbine blades 34 is discharged into the flow path of the high pressure turbine 38. More specifically, the cooling air in passageways 35 exits via film cooling holes formed in the static turbine vanes 32 and the rotating turbine blades 34.

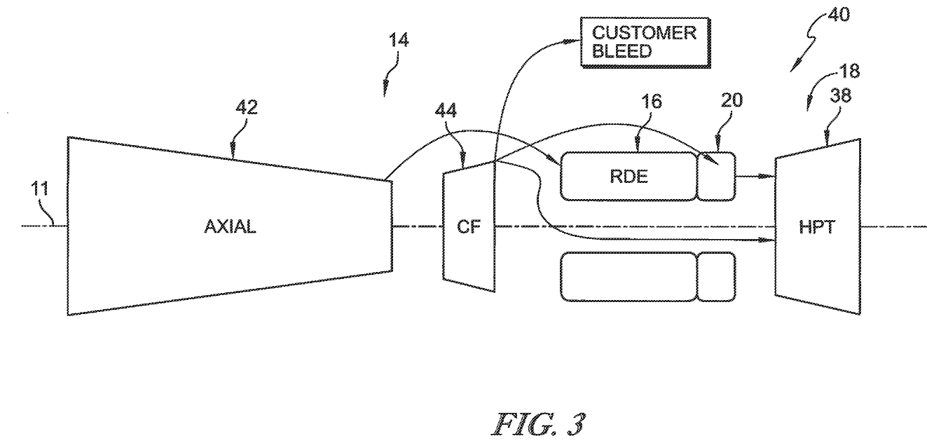

Turning now to FIG. 3, a diagrammatic view of a high pressure turbine spool 40 and combustor 16 like that shown in FIG. 1 is presented. FIG. 3 shows that the primary compressor rotor 15 includes axial compression stages 42 and a centrifugal stage 44. The diagram also shows various paths of compressed air flow from the primary compressor 14. Specifically, compressed air can flow from the compressor 14 to a customer bleed 45, to the rotating detonation pressure gain combustor 16, to the turbine system 18, and/or to the auxiliary compressor 20. Compressed air suppled to the auxiliary compressor 20 can be further pressurized and then delivered to the turbine system 18 and/or to a cooled combustion liner 60 via cooling ports 61.

Embodiments of the present disclosure can include an extra compression stage-sometimes called an integrated cooling air compressor or auxiliary compressor. The extra compression stage may be on the centerline of the engine and configured to compress cooling air, suggested FIG. 2. A physical implementation of this might include a gear ratio to adjust tip speed on the auxiliary compressor.

An optional intercooler on the bleed flow prior to the compression stage might be added to prevent over-temping the extra stage. Moreover, it is contemplated that the optional intercooler may be positioned downstream of the extra compression stage to utilize pressure added to cooling air moving toward the turbine system.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A gas turbine engine, the engine comprising:
a primary compressor including a primary compressor rotor mounted for rotation about an engine axis, the primary compressor configured to compress air drawn into the engine,
a pressure gain combustor configured to produce a mixture of fuel and a first portion of the compressed air, ignite the mixture, and to discharge products of the combustion reaction at a discharge pressure greater than an inlet pressure into the pressure gain combustor upstream of ignition,
a turbine system that defines a flow path across which static vanes and rotating blades extend, the flow path fluidly coupled to the pressure gain combustor so as to receive products of the combustion reaction, and the static vanes and rotating blades formed to include cooling air passageways shaped to carry cooling air therethrough to lower the temperature of the associated static vanes and rotating blades, and
an auxiliary compressor including an auxiliary compressor rotor mounted for rotation about the engine axis, the auxiliary compressor being fluidly coupled to the primary compressor and to the cooling air passageways of the turbine system, the auxiliary compressor being configured to increase the pressure of a second portion of the compressed air received from the primary compressor upstream of the cooling air passageways of the turbine system to overcome pressure within the flow path,
wherein a third portion of the compressed air is directed from the primary compressor to the turbine system and the third portion of the compressed air bypasses the pressure gain combustor and the auxiliary compressor.

2. The engine of claim 1, wherein the auxiliary compressor rotor is coupled to the primary compressor rotor for rotation therewith.

3. The engine of claim 2, wherein the primary compressor rotor is mounted within a compressor case that includes a bleed port in fluid communication with the auxiliary compressor rotor.

4. The engine of claim 3, wherein the primary compressor rotor is a centrifugal compressor rotor and the compressor case includes a backing plate in which the bleed port is formed.

5. The engine of claim 1, wherein the auxiliary compressor rotor is an axial compressor rotor.

6. The engine of claim 5, wherein the auxiliary compressor rotor has a single stage of compressor blades.

7. The engine of claim 1, further including an intercooler configured to cool the second portion of the compressed air that interacts with the auxiliary compressor rotor.

8. The engine of claim 7, wherein the intercooler is fluidly coupled between the auxiliary compressor rotor and the turbine system.

9. The engine of claim 8, wherein the intercooler is an air-to-fuel heat exchanger configured to transfer heat from the second portion of the compressed air after interaction with the auxiliary compressor rotor to fuel prior to mixing of the fuel within the pressure gain combustor.

10. The engine of claim 1, wherein the pressure gain combustor is a rotating detonation combustor.

11. A gas turbine engine, the engine comprising:
a primary compressor rotor mounted for rotation about an engine axis,
a turbine system including airfoils, the airfoils formed to include cooling air passageways therethrough, and
an auxiliary compressor rotor mounted for rotation about the engine axis, the auxiliary compressor rotor being fluidly coupled between the primary compressor rotor and to the cooling air passageways of the turbine system, the auxiliary compressor rotor being configured to increase the pressure of compressed air after interaction with the primary compressor rotor,
wherein a portion of the compressed air flows directly to the turbine system after interaction with the primary compressor rotor to bypass interaction with the auxiliary compressor rotor and to bypass interaction with a combustor included in the engine.

12. The engine of claim 11, wherein the auxiliary compressor rotor is coupled to the primary compressor rotor for rotation therewith.

13. The engine of claim 12, wherein the primary compressor rotor is mounted within a compressor case that includes a bleed port in fluid communication with the auxiliary compressor rotor.

14. The engine of claim 13, wherein the primary compressor rotor is a centrifugal compressor rotor and the compressor case includes a backing plate in which the bleed port is formed.

15. The engine of claim 11, wherein the auxiliary compressor rotor is an axial compressor rotor.

16. The engine of claim 15, wherein the auxiliary compressor rotor has a single stage of compressor blades.

17. The engine of claim 11, further including an intercooler configured to cool compressed air that interacts with the auxiliary compressor rotor.

18. The engine of claim 17, wherein the intercooler is located upstream of the auxiliary compressor rotor.

19. The engine of claim 17, wherein the intercooler is located between the auxiliary compressor rotor and the turbine system.

20. A gas turbine engine, the engine comprising:
a primary compressor rotor mounted for rotation about an engine axis,
a combustor including a combustion liner formed to include cooling air passageways therethrough, wherein a first portion of compressed air is directed to the combustor after interaction with the primary compressor rotor,
an auxiliary compressor rotor mounted for rotation about the engine axis, the auxiliary compressor rotor being fluidly coupled between the primary compressor rotor and to the cooling air passageways of the combustor, the auxiliary compressor rotor being configured to increase the pressure of a second portion of the compressed air after interaction with the primary compressor rotor, and
a turbine system downstream of the combustor, wherein a third portion of the compressed air is directed to the turbine system after interaction with the primary compressor rotor to bypass the combustor and to bypass interaction with the auxiliary compressor rotor.
